(19) United States
(12) Patent Application Publication
(10) Pub. No.: US 2024/0228191 A1
(43) Pub. Date: Jul. 11, 2024

(54) MULTIPLE ROBOT SIMULTANEOUS AND SYNCHRONOUS PICK AND PLACE

(71) Applicant: Dexterity, Inc., Redwood City, CA (US)

(72) Inventors: Shitij Kumar, Santa Clara, CA (US); Michael Root, Santa Clara, CA (US); Varun Uday Nayak, Santa Clara, CA (US); Cuthbert Sun, San Francisco, CA (US); Kunal Shah, San Mateo, CA (US); Yuan Gao, Santa Clara, CA (US); Zhouwen Sun, San Mateo, CA (US); Andrew Bylard, San Mateo, CA (US); Diego Rodriguez, San Mateo, CA (US); Samir Menon, Menlo Park, CA (US)

(21) Appl. No.: 18/393,504

(22) Filed: Dec. 21, 2023

Related U.S. Application Data
(60) Provisional application No. 63/435,085, filed on Dec. 23, 2022.

(51) Int. Cl. B65G 47/90

(52) U.S. Cl. CPC B65G 47/905

(57) ABSTRACT

A robotic system receives from a first agent included in a plurality of robotically controlled agents a request to be provided a motion plan to perform a first pick and place task assigned to the first agent. A first motion plan is determined for the first agent, including by taking into consideration a second motion plan associated with a second agent included in the plurality of robotically controlled agents to perform a second pick and place task assigned to the second agent, at least in part by considering a swept volume associated with at least a remaining uncompleted portion of the second motion plan as an obstacle with which the first agent will not collide while implementing the first motion plan.

### CROSS REFERENCE TO OTHER APPLICATIONS

This application claims priority to U.S. Provisional Patent Application No. 63/435,085 entitled DUAL ROBOT SIMULTANEOUS AND SYNCHRONOUS PICK AND PLACE filed Dec. 23, 2022, which is incorporated herein by reference for all purposes.

### BACKGROUND OF THE INVENTION

Robots have been provided to perform a variety of tasks, including the handling of boxes and other items. Examples include, without limitation, stacking items on a pallet or removing them from a pallet, loading items into or unloading them from a truck or other container, singulation or sortation operations, picking items from shelves to form kits, or picking and placing items along a kitting line or similar operation.

To increase throughput, it may be advantageous to use a plurality of robots to perform such tasks. When multiple robots share a common workspace, care must be taken to pick and place objects from the overlapping robot workspace without colliding. In a typical approach, this is achieved by having a single robot lock the entire workspace and at any given time, so that only that one robot would occupy it. Under such an approach, robots other than the one for which the overlapping workspace has been locked remain inactive, or at least not active in the overlapping part of the workspace, waiting for their turn to lock and operate within the shared workspace.

### BRIEF DESCRIPTION OF THE DRAWINGS

Various embodiments of the invention are disclosed in the following detailed description and the accompanying drawings.

FIG. 1 is a block diagram illustrating an embodiment of a system to use multiple robotic agents simultaneously and synchronously to pick/place.

FIG. 2 is a flow diagram illustrating an embodiment of a process to use multiple robotic agents simultaneously and synchronously to pick/place.

FIG. 3 is a block diagram illustrating an embodiment of a motion orchestrator comprising a system to use multiple robotic agents simultaneously and synchronously to pick/place.

FIG. 4 is a flow diagram illustrating an embodiment of a process to use multiple robotic agents simultaneously and synchronously to pick/place.

FIG. 5A is a diagram illustrating an example of a scenario in which multiple robotic agents are used simultaneously and synchronously to pick/place.

FIG. 5B is a diagram illustrating an example of a scenario in which multiple robotic agents are used simultaneously and synchronously to pick/place.

FIG. 5C is a diagram illustrating an example of a scenario in which multiple robotic agents are used simultaneously and synchronously to pick/place.

FIG. 5D is a diagram illustrating an example of a scenario in which multiple robotic agents are used simultaneously and synchronously to pick/place.

FIG. 6A is a diagram illustrating an embodiment of a control loop comprising a system to use multiple robotic agents simultaneously and synchronously to pick/place.

FIG. 6B is a diagram illustrating an embodiment of a robotic system in which each robot/agent has its own instance of a synchronized robot motion control loop.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Techniques are disclosed to use multiple robots to work simultaneously in a shared workspace, without collision. In various embodiments, the operation of the robots is synchronized to ensure they do not collide. In some embodiments, a swept volume associated with the expected motion of a first robot and its payload, such as an item in its grasp, through (a remaining portion of) a first trajectory that has been assigned to the first robot is considered in determining a second trajectory to be assigned to a second robot to perform a task. The second trajectory is computed to avoid intersecting the swept volume, for example. In some embodiments, the swept volume associated with the first robot and its first trajectory is included in a “collision world” or other representation of obstacles required to be avoided in determining the second trajectory for the second robot. In various embodiments, the swept volume is updated based on one or more of progress information reported by the first robot, e.g., how far along the first trajectory it has traveled, and perception system information, such as computer vision information based on cameras or other sensors in the workspace and/or on the robots. For example, an updated swept volume may be determined based on update information from the first robot and/or the perception, enabling a second (or subsequent) trajectory to be determined that would pass through space through which the first robot has already passed and/or is anticipated it will have passed through by the time the second robot following the second trajectory would get to the same space.

The terms “robot” and “agent” are used interchangeably herein to refer to a robotically controlled instrumentality, such as a robotic arm, a cartesian robot, a mobile robot, such as a robotic arm mounted on a mobile chassis or a robotic transporter such as a robotic cart or flat bed or forklift, a robotically-controlled conveyor or other conveyance structure, a robotically-activated structure to gate, segment, block, disrupt, eject, or otherwise move one or more items or a flow or other set of items, etc. In various embodiments, a mix of robotically controlled “agents” may be used and operated synchronously, without collision, as disclosed herein.

In various embodiments, a system as disclosed herein includes a centralized orchestrator, through which each agent is operated in a manner that considers the other agents' planned motions and its live progress along the trajectory of its motion during execution. In various embodiments, any agent can request a motion from the centralized orchestrator, and the orchestrator provides a collision free trajectory (motion plan) that is optimal with respect to time and which accounts for all other agents' current and future states along their respective trajectories.

In various embodiments, each trajectory is executed and controlled precisely not only in space but also time to avoid collisions.

In various embodiments, the centralized orchestrator subscribes to information from a perception system so that it always uses the latest state of the objects that an agent can collide with to plan an agent's motion.

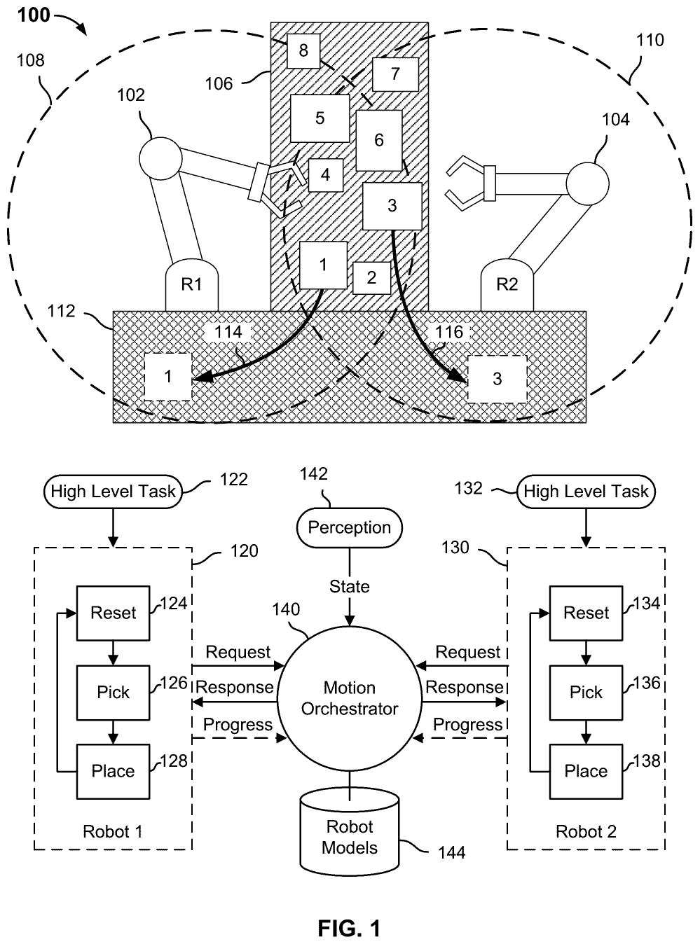

FIG. 1 is a block diagram illustrating an embodiment of a system to use multiple robotic agents simultaneously and synchronously to pick/place. In the example shown, robotic system 100 includes a first robot (agent) 102 and a second robot 104 mounted (in fixed positions, in this example) on either side of a pick conveyor 106. In some embodiments, pick conveyor 106 comprises a robotically-controlled conveyance structure that moves items, under robotic control, into locations from which the robots 102 and 104, e.g., robotic arms terminating in grippers, in this example, can grasp them. For example, a vision (or other perception) system may monitor a pick region of pick conveyor 106 and may advance the pick conveyor 106 as needed to move additional items into range to be picked. In the example shown, reach circles 108 and 110 indicate the respective reachable areas of robots 102 and 104.

In various embodiments, system 100 is configured to use robots 102, 104 to pick items from a pick region of pick conveyor 106 and place each item in a corresponding destination location in a place structure or area 112. Examples of a place structure or area 112 include, without limitation, an output conveyor or other conveyance structure, e.g., as in a singulation or sortation application; a pallet, bin, container, or other receptacle, e.g., in a palletization or kitting application; and truck or other shipping container; etc.

In the example shown, reach circles 108 and 110 overlap in a first overlap area of the pick conveyor 106 and a second overlap area of the destination area or structure 112. Such overlap allows the robots 102, 104 to be used to both pick items from or place items in the overlap areas, but such areas also create risks of collision. In various embodiments, techniques disclosed herein are used to enable robots 102, 104 to be used to pick/place items with high throughput and no collisions.

In the scenario illustrated in FIG. 1, a set of eight boxes, numbered “1” through “8”, are present on pick conveyor 106. In this example, robot 102 has been tasked with moving the box labeled “1” from the source location shown to a destination location shown in dashed lines, via trajectory 114. Similarly, robot 104 has been tasked with moving the box labeled “3” from the source location shown to a destination location shown in dashed lines, via trajectory 116. In this case, while both robots 102, 104 pick from the region in which their reach circles 108, 110 overlap, due to the position of the boxes and the destination locations the robots may work simultaneously, and to pick it's assigned box and move it via its assigned trajectory to the destination location. In other cases, techniques disclosed herein may be used to determine and assign a trajectory for each robot 102, 104 to perform its assigned task without risk of collision. Examples include, without limitation, cases in which one of the robots 102, 104 is assigned to move first, e.g., to clear the item it is assigned to pick/place and/or itself out of the way to create a collision free path for the other robot to perform its assigned task. These and other scenarios are described further below.

Referring to the control elements in the lower part of FIG. 1, system 100 includes a first robot controller 120 associated with the first robot 102 and a second robot controller 130 associated with the second robot 104. Each of the robot controllers 120, 130 receives a high-level task 122, 132 assigned to that robot, e.g., by a high-level scheduler or application. For example, in the example shown at the top of FIG. 1, an item and task selection process may have determined, e.g., based on computer vision information, that the boxes “1” and “3” should be picked/placed next and each moved to a corresponding destination location as shown in the top part of FIG. 1. The same process may have determined that the task to move box “1” would be assigned to robot 102 and the task to move box “3” would be assigned to robot 104. Each of the respective controllers 120, 130 includes states and associated processes to move and until tasked remain in a reset position 124, 134 (in some embodiments, the reset poses for both robots 102, 104 may be assumed to be a fixed reset pose that lies in the non-overlapping operating workspaces of each robot); a state and operation 126, 136 to pick an assigned item, e.g., by moving along an assigned trajectory from reset to the pick location, with its end effector in a position and orientation associated with a strategy to grasp the item; and a place state and operation 128, 138.

In a typical prior system, each robot's 102, 104 controller 120, 130 may operate in isolation to pick/place items as assigned. To work in a shared portion of a workspace, a robot 102, 104 may obtain or be granted a “lock” to operate exclusively in the shared region; other robots would wait while the lock remained in place. Using techniques disclosed herein, in various embodiments, the robots 102, 104 may be operated synchronously/simultaneously, each to perform its task in a manner that does not risk collision with the other.

Referring further to the lower half of FIG. 1, in the example shown, once assigned a task 122, 132, the respective robot controllers 120, 130 each makes a request to motion orchestrator 140 for a trajectory to pick and place the item the robot 102, 104 associated with that controller 120, 130 has been assigned 122, 132 to pick and place. The motion orchestrator uses one or more of the following to determine if a collision-free trajectory can be assigned and, if so, what that trajectory should be: (1) input from a perception system 142, e.g., a computer vision system, which estimates state of the workspace, including items present in the workspace and agents working therein, e.g., based on data generated by 3D cameras or other sensors present in the workspace; (2) robot models 144, representing the elements comprising and kinematics and/or other capabilities and/or limitations of each robot 102, 104 and/or other robotically-controlled agents in the workspace; and (3) progress reports from robots or other agents that have been assigned plans/trajectories through which to move.

Based on the perceived, estimated, and/or reported state of the workspace and agents acting therein, motion orchestrator 140 uses techniques disclosed herein to a for each received and pending request a corresponding response. The response may include, in various embodiments, a rejection of the task (e.g., a collision-free trajectory or motion plan does not exist and/or cannot be determined); an instruction to wait; and, ideally, a motion plan that specifies a collision free trajectory to perform the task assigned to the robot with which the request is associated.

As noted, in various embodiments, a robot or other agent to which motion orchestrator 140 has provided a motion plan may report its progress. The progress reports may be used to update the “collision world” used to process subsequent and/or pending requests from other agents, e.g., by reducing the “swept volume” as described above, e.g., to omit space through which the robot, including its component elements and the item (if any) it has in its grasped have already moved.

While two robots 102, 104 are present in the example shown in FIG. 1, in other embodiments three or more robots may be present in the same workspace. Also, while in the example shown in FIG. 1 the robots 102, 104 and other agents (e.g., 106) are shown in fixed positions, in other embodiments one or more mobile robots or other mobile agents may be used and controlled as disclosed herein. In various embodiments, techniques disclosed herein may be used to control two or more robots and/or other agents having the potential to collide or otherwise interfere with each other if techniques disclosed herein were not used to provide synchronous/simultaneous collision-free motion with high utilization and throughput.

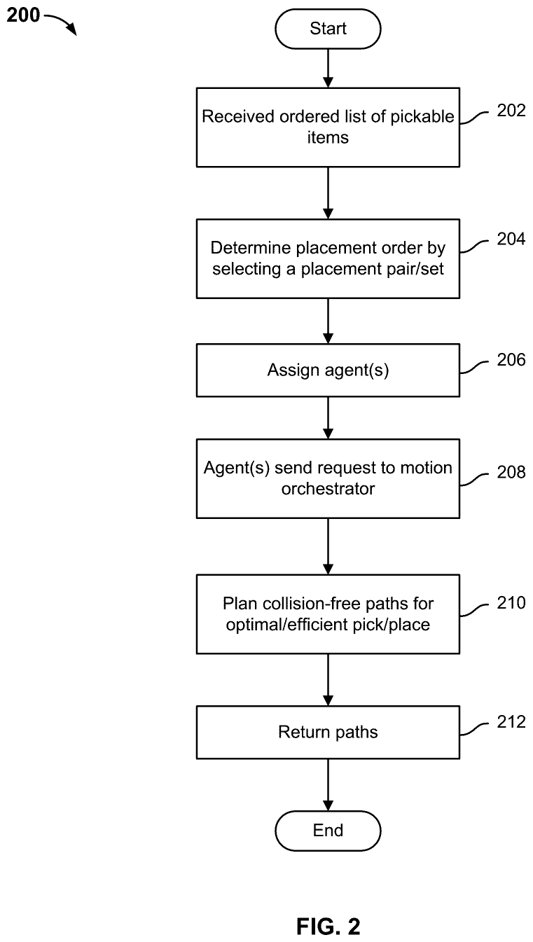

FIG. 2 is a flow diagram illustrating an embodiment of a process to use multiple robotic agents simultaneously and synchronously to pick/place. In various embodiments, the process 200 of FIG. 2 may be implemented by a control computer, such as a computer configured to provide a motion orchestrator, such as motion orchestrator 140 of FIG. 1. In the example shown, at 202 an ordered list of pickable items is received. For example, in the example shown in FIG. 1, a list of pickable items numbered sequentially, “1” through “8”, may be determined.

In some embodiments, the ordered list is a list determined by the perception system as the most preferable boxes to pick first. Examples of the criteria used include, without limitation, the proximity to the place location (it would be faster to pick and place and help advance the conveyor), is it overlapping or under another box, etc. Referring further to FIG. 1, an example of an ordered list received at 202 is {1, 2, 3, 4, 5, 6}, indicating those six boxes are pickable by both robots 102, 104 in the sequential order of preference as determined by the perception system.

At 204, placement order is determined. For example, all possible placement pairs (or sets of n items, if n agents are present and available; in this example n=2) may be considered and a particular pair selected to be picked/placed first, e.g., {1, 3} in the example shown in FIG. 1. In various embodiments, a decision-making algorithm chooses a pair based on one or more criteria associated with the operation/application the robotic system is being used to perform. For example, in the case of packing a container or stacking on a pallet, a pair may be selected (e.g., based on size, weight, dimensions, rigidity, or other attributes) that would result in higher packing density and stability of packed boxes. Respective placement positions are determined for each item/box. In this example, pair {1, 3} has been selected to be placed (first/next), and the respective placement locations lie within the reach of one or both of the robots.

At 206, robots (agents) are assigned to a particular task. For example, robot 102 may be assigned to pick/place box “1” while robot 104 is assigned to pick/place box “3”. In this example, the pick location of each box lies within the reach of both robots, but the placement location of box “1” lies only within the reach of robot 102 while the placement location of box “3” lies only within the reach of robot 104. In other examples, in which the placement locations of both items are within the reach of both robots, other selection criteria may be applied, such as which robot has an unobstructed path to pick a given item, which robot is closer to the item, etc.

In various embodiments, steps 202, 204, and 206 of FIG. 2 may be performed by one or more higher level processes, e.g., running on a control computer.

At 208, each agent that has been assigned a task makes a request to the motion orchestrator to obtain a motion plan (trajectory, etc.) to perform its task. At 210, the motion orchestrator determines collision-free paths (motion plans, trajectories, etc.) for both (or all n) robots/agents. In various embodiments, the robot/agent motions are planned to maximize the collective utilization and/or throughput of all robots/agents. In some embodiments, motions are planned such that the robots/agents operate, to the extent safely possible, simultaneously. If safe, collision-free motion plans that involve simultaneous operation are not possible, the most globally efficient/optimal set of motion plans that call for the robots/agents to operate (at least in part) sequentially may be produced. At 212, the respective collision-free paths determined by the motion orchestrator are returned to the respective robot/agent controllers, e.g., 120, 130 of FIG. 1.

In various embodiments, the motion plans generated at 210 may include plans to for the robots/agents to operate sequentially if one or more of the following is/are true:
If the robots would be in collision at the terminal state of the motion, e.g., at the pick location in the case of motions from reset to pick.
   In some embodiments, partially synchronous pick/place may be considered, e.g., a motion plan may be returned that involves a first robot (e.g., 102) doing reset to pick, while a second robot (e.g., 104) is moving from pick to place.
The place location for a pair of box lies in the overlapping workspace. There may exist a path where both robots would not collide even when placing in the overlapping reachable region, but this increases the complexity of finding such a solution and, in various embodiments, motion plans for sequential pick/place may be produced in such a case (in which the place locations lie in the overlapping workspace).

By contrast, situations in which motion plans for simultaneous/synchronous pick and place may be determined at 210 include the case in which the place location of a first box in the pair is exclusively in the reach circle of a first robot and the place location of the second box is exclusively in the reach circle of the second (or nth) robot.

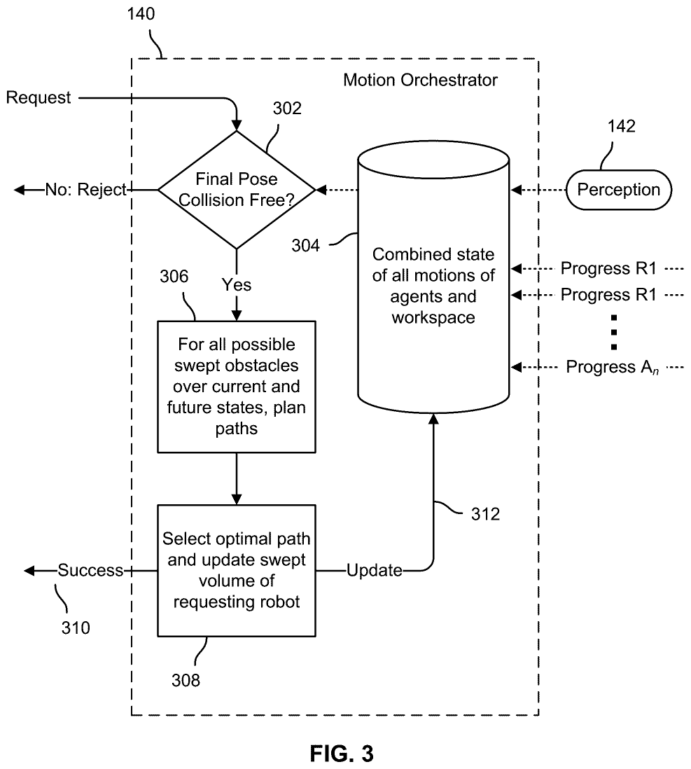

FIG. 3 is a block diagram illustrating an embodiment of a motion orchestrator comprising a system to use multiple robotic agents simultaneously and synchronously to pick/place. In the example shown, motion orchestrator 140 of FIG. 1 receives a request, e.g., from a robot controller 120, 130, to perform a pick/place task, such as to pick a specific item from a pick location of that item and move it to and place it at a placement location for the item. At 302, motion orchestrator 140 determines if the final pose, i.e., of the requesting robot and the item it would be carrying, is collision free. If not, e.g., another robot/agent is in the process of moving to or through the same location, the request is rejected. In various embodiments, rejection of a request may trigger exception handling, such as assignment of a different or modified task, such as to place the item in a different location or to pick/place a different item.

To make the determination at 302 and/or perform other actions, motion orchestrator 140 uses the combined state 304 of all motions of all robots/agents in the workspace. Such information may be obtained from the motion plans (paths, trajectories) assigned by motion orchestrator 140 to robots/agents, the progress reported by such agents, and information from perception system 142.

If it is determined at 302 that the final pose is collision free, at 306 motion orchestrator 140 determines a path for each request considering all possible swept obstacles over all current and future states. For example, if requests to pick/place boxes “1” and “3” in the example above are received, motion orchestrator 140 may consider a number of possible motion plans (paths) for each robot and for each compute the swept obstacles associated with that path. At 308, the paths and associated swept obstacles are considered to determine for each request an optimal collision-free path (or set of collision free paths) to return as a response 310. The selected and assigned paths as used to update 312 to combined state information 304, e.g., to include initial swept obstacle information for the selected/assigned paths. Subsequently, progress reports from the robots/agents and/or perception information 142 may be used to update the swept obstacles, e.g., to omit regions of space through which the robot/agent has already moved.

In various embodiment, motion planning for collision free paths, as disclosed herein, may include one or more of the following:
² Finding collision free paths for each robot using motion planning methodologies of searching states of robot that are collision free and finding a trajectory from start to goal.
² Constructing a collision world and checking each robot state and if is in collision with the obstacles in the space.
² In some embodiments, each of a robot's links and the box/item it is carrying is represented as simple convex shapes at each joint configuration corresponding to the point on the path.
   ² Representing the robot links with the box at a given pose as an obstacle
   ² The swept obstacle space is defined as the union of these objects in the collision world at each of the poses along the trajectory. The resolution of these obstacles can be represented coarsely and doesn't need to be high resolution. The higher the resolution the closer the robots can move to each other without colliding. This resolution can be as wide as the entire robot link or as small as the buffer around obstacles during collision checking.
   ² This swept obstacle represents the volume of space that would be occupied by a robot arm following a path.
   ² We use this swept obstacle as a part of the collision world for the other robot to plan a path such that it does not collide with it.
   ² If a path exists, that means as long as both robots follow the determined paths their paths will not overlap, and they can be executed synchronously.
   ² Searching for paths and generation of obstacles can be done in parallel to robots executing motions, thereby hiding the time it takes for planning synchronous motions.
   ² This allows faster finding collision free trajectories and post processing them to be smoother. The planning times can range from 5-40 ms per query, in some embodiments.
² Inputs: robot start pose, robot goal pose, collision world, geometry of object held by the robot.
² Output: set of poses representing a collision free trajectory
² This motion planning may be leveraged to determine synchronous robot motions using the swept obstacles technique disclosed herein.
² A swept obstacle workspace (“world”) is generated for a given path of the robot.

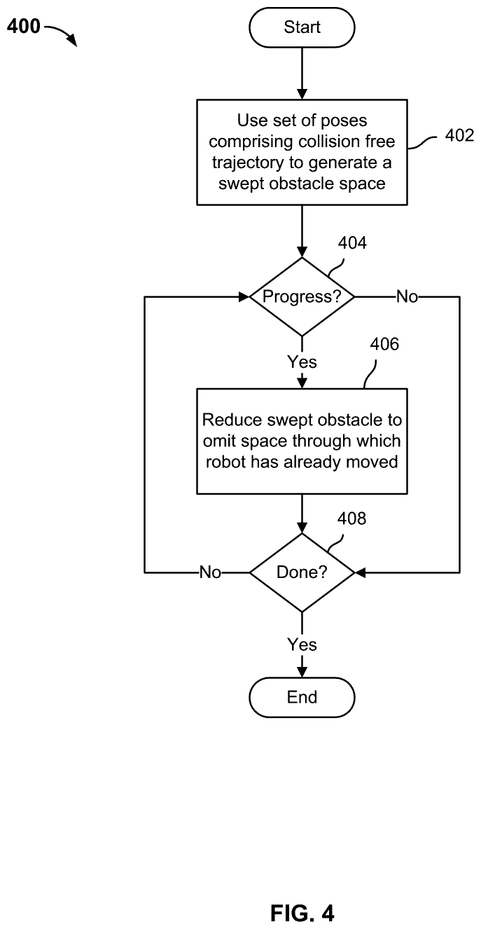

FIG. 4 is a flow diagram illustrating an embodiment of a process to use multiple robotic agents simultaneously and synchronously to pick/place. In various embodiments, the process 400 of FIG. 4 may be performed by a motion orchestrator, such as motion orchestrator 140 of FIG. 1. In the example shown, at 402, a set of poses comprising a collision free path (trajectory) determined for a robot/agent is used to generate a swept obstacle space. At 404, if progress along the path/trajectory is repeated, then at 406 the swept obstacle space determined at 402 is reduced, e.g., to omit space through which the robot/agent has already moved. Successive updates to the swept obstacle space are made as/if subsequent progress reports is/are received (404, 406) until the process 400 is completed (408), e.g., the robot/agent has reported and/or been observed to have completed movement through the assigned trajectory.

In various embodiments, future states may be considered in determining a collision free trajectory. For example, in some embodiments, a motion orchestrator as disclosed herein may anticipate and consider future states, e.g., in which a first robot has moved through a first set of states comprising an assigned trajectory, in planning a path for a second robot. In some cases, a leader robot/agent may be selected and assigned a first trajectory comprising a first set of states (poses, locations, anticipated times, etc.). A trajectory for a second robot may be determined based on an anticipated future state of the first robot. For example, a path for a second, “follower” robot may include a wait time, e.g., at reset, to allow the first robot to move through a first part of its trajectory, followed by the second robot moving through its assigned trajectory. The first and second trajectories may overlap in space, but by designating the first robot as the “leader” the trajectories do not overlap in space-time, resulting in a collision free path for both.

In various embodiments a leader and/or follower robot/agent may be determined and/or controlled as follows:
Motion orchestration is general in the sense that robot/agents can autonomously request motions at any given time i.e. agents can decide where they want to move and the orchestrator rejects/grants those requests from that point onwards
However, in some cases, it could be beneficial to introduce the concept of leader and follower to further optimize coordinated motions in the case of 2 robots. One robot (the leader) can go before the other robot (the follower), implying that the follower robot would be subject to swept volume obstacles of the leader robot.
There can be many strategies that can be applied to determine the leader and the follower. Here we present a simple one
The determination of leader and follower needs to consider the following:
   The start and goal pose
   The following robot motion, hee in this case, reset to pick, pick to place and place to reset.
For reset to pick motion for a first robot and a second robot
   in this case the robot that is picking farthest from the place location should be the leader.
   the simple reason is that the robot that is closest will not be blocked in the following motion from pick to place where the follower will be the leader.
For pick to place motions
   The robot closest to the place location is the leader.
   This ensures that the robot is unblocked to continue placing

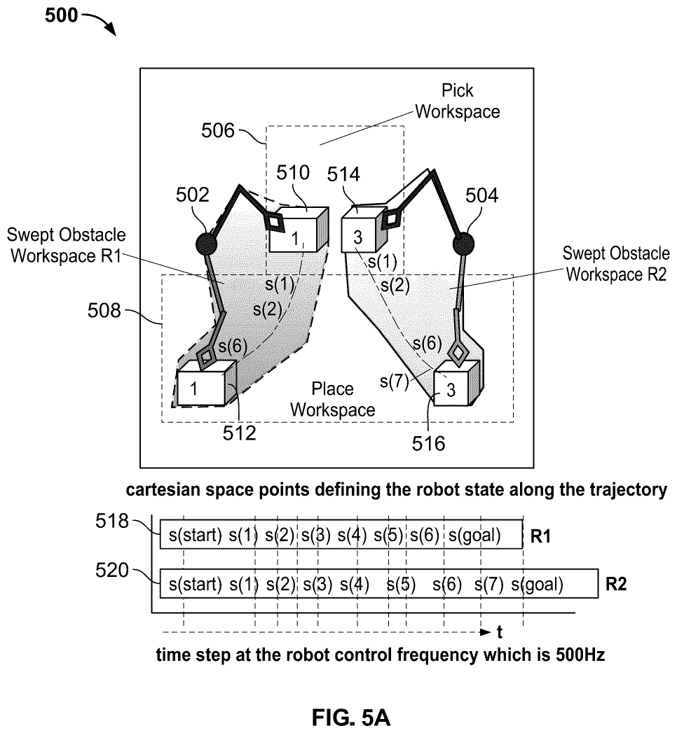

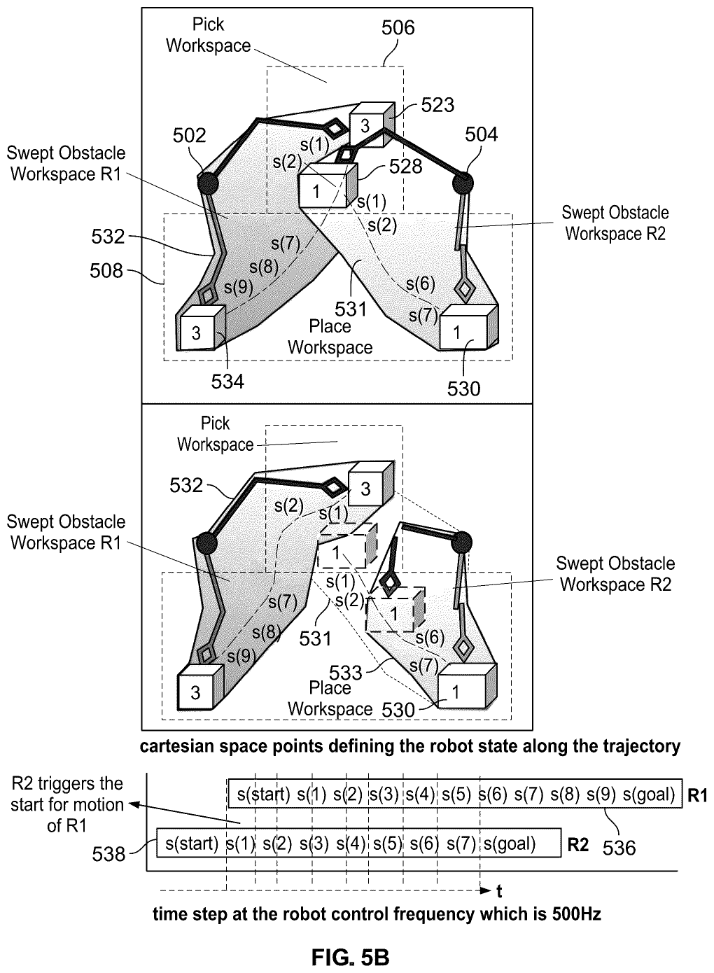

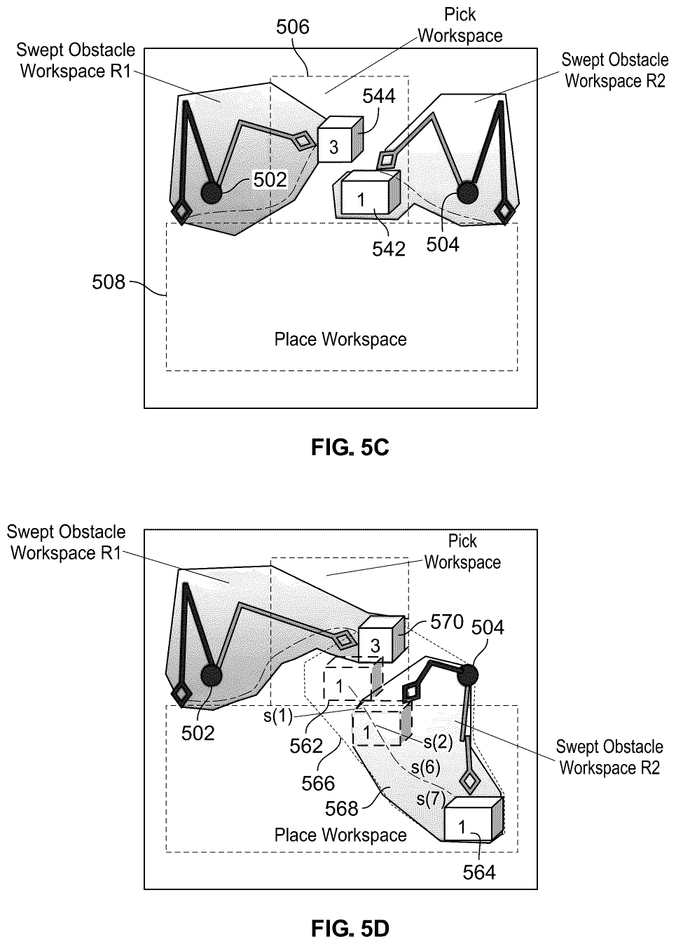

FIG. 5A is a diagram illustrating an example of a scenario in which multiple robotic agents are used simultaneously and synchronously to pick/place. In the example shown, robots 502, 504 are configured to pick items from conveyor 506 and place them in placement area 508. Robot 502 has been assigned pick box “1” from pick location 510 and place it in placement location 512, while robot 504 has been assigned to pick box “3” from pick location 514 and place it in placement location 516. In the scenario shown in FIG. 5A, the paths 518, 520 found and their swept obstacle workspaces are not overlapping and can be executed together.

FIG. 5B is a diagram illustrating an example of a scenario in which multiple robotic agents are used simultaneously and synchronously to pick/place. In this figure, the upper portion represents the state at time zero, at which time the robot 504 has not yet begun to move the box “1” along the trajectory 538 assigned to it to move box “1” from pick location 528 to placement location 530. Robot 502 has been assigned trajectory 536 to move box “3” from pick location 523 to placement location 534. In this scenario, the swept obstacle spaces 531, 532 associated with the respective trajectories 536, 538 overlap, making it not possible for the robots 502, 504 to follow their assigned trajectories at the same time without collision. As a result, in this example, robot 504 has been selected to begin to implement its motion plan 538 first. Once robot 504 has moved through the first part of its trajectory 538 (i.e., states s(start) and s(1)—as illustrated in the middle portion of FIG. 5B, robot 502 begins its motion. As shown in the middle part of FIG. 5B, by the time robot 502 begins its motion, the swept obstacle 531 associated with what remains of the trajectory 538 of robot 504 has been reduced to an updated/remaining swept obstacle 533, which no longer overlaps with the swept obstacle 532 of the trajectory 536 assigned to robot 502.

In some embodiments, further optimization may be achieved by assigning to robot 502 a partial path to get started “early” (i.e., before robot 504 advances to the state s(2)), e.g., by following a partial path that avoids overlap of the original swept obstacle 531 of robot 504. The robot 502 would return to the original trajectory 536 once clear of the swept obstacle 531 of robot 504.

FIG. 5C is a diagram illustrating an example of a scenario in which multiple robotic agents are used simultaneously and synchronously to pick/place. In the example shown, robot 502 is trying to pick box “3” (544) that is farthest (i.e., farther than box “1” (542)) from its placement location. In various embodiments, as long as the respective end poses at pick (i.e., of robot 502 with respect to box “3” and robot 504 with respect to box “1”) are not overlapping a parallel motion can be executed. For example, robot 502 may be designated the leader to pick (reset to pick motion), since box “3” is further both from the robots 502, 504 and its placement position, but once both have picked robot 504 may be told to go first to place (pick to place motion), so that it moves out of the way enabling robot 502 to follow the most (or a more) efficient or direct path from pick to place.

FIG. 5D is a diagram illustrating an example of a scenario in which multiple robotic agents are used simultaneously and synchronously to pick/place. In the example shown, two different motions are sequenced. For example, robot 502 may perform its reset to pick motion, to pick box “3” (570) at the same time robot 504 is doing its pick to place motion. By the time robot 502 is ready to move from pick to place, robot 504 will already have moved into the position and state as shown in FIG. 5D. That is, the box “1” would have been moved from pick location 562 associated with original swept obstacle 566 to the intermediate position shown, with associated updated swept obstacle 568. Robot 502 then has a clear path to pick and move box “3”, while robot 504 continues on to place box “1” at placement location 564.

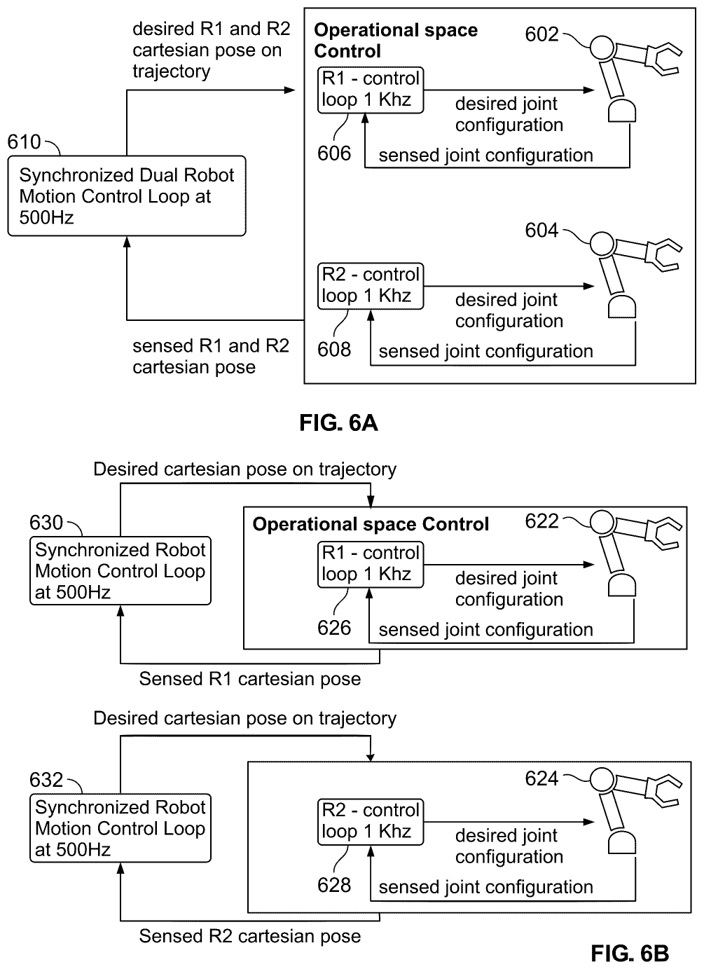

FIG. 6A is a diagram illustrating an embodiment of a control loop comprising a system to use multiple robotic agents simultaneously and synchronously to pick/place. In the example shown, each robot 602, 604 is controlled (“operational space control”) by an associated control loop 606, 608 operating at 1 kHz, while a synchronized dual (or other multiple) robot motion control loop 610, implementing techniques disclosed herein, operates at 500 Hz.

In various embodiments, a system as disclosed herein precisely controls and follows the desired trajectory for both (or all n) of the robots/agents. In the example shown in FIG. 6A, this is achieved by commanding both robots/agents at smaller incremental timesteps, e.g., at the rate of 500 Hz. In various embodiments, robot/agent trajectories are splined and discretized to enable following to be done with sub-centimeter precision, where each point in trajectory has a defined pose in terms of position and orientation of the end effector that is mapped to corresponding joint configurations.

FIG. 6B is a diagram illustrating an embodiment of a robotic system in which each robot/agent has its own instance of a synchronized robot motion control loop. In the example shown, each robot/agent 622, 624 is controlled (“operational space control”) by an associated control loop 626, 628 operating at 1 kHz, and each has its own instance 630, 632 of a synchronized robot motion control loop, implementing techniques disclosed herein, operating at 500 Hz.

In various embodiments, two or more robots/agents may be operated synchronously/simultaneously using a single, shared instance of an outer motion control loop (e.g., 610 of FIG. 6A) in certain circumstances. For example, if a robot includes two robotic arms on either side of a robotically controlled central conveyor, and the robotic arms are being used to pick/place a large and/or heavy item cooperatively, then the motion plans provided by the motion orchestrator for all three robots/agents (robotic arm 1, robotic arm 2, and conveyor) may be implemented under the supervision and control of a single instance of an outer control loop. By contrast, for robots/agents that work independently but in the same workspace, each may be assigned a motion plan and implementation of the plan may be performed and supervised by a corresponding robot/agent specific instance of the outer control loop, as in the example shown in FIG. 6B. In some such embodiments, a single instance of an outer-outer control loop may be provided to coordinate implementation of the respective motion plans, in synchronization, by the robot/agent specific instances of the robot/agent motion control loops 630, 632 shown in FIG. 6B.

In some embodiments, the approach shown in FIG. 6A or the approach shown in FIG. 6B may be selected an configured dynamically, depending on the robots/agents and the pick/place or other tasks they have been assigned. If close coordination is needed, because the robots/agents are working very near each other and/or to perform a cooperative task, a single instance of the outer control loop may be used, as in FIG. 6A. By contrast, if the same robots/agents are assigned to perform separate and independent tasks that require less close coordination, each may be assigned dynamically to be controlled by a dedicated corresponding instance of the outer control loop, as in FIG. 6B.

While FIGS. 6A and 6B show two robots/agents, the same principles may be applied to any number of robots/agents. In some embodiments, the approaches shown in FIGS. 6A and 6B may be mixed and matched, depending on the relative degree of coordination required between a given group of two or more robots/agents, for example.

While in certain examples described herein position control is described, e.g., specifying a trajectory in terms of the location and pose of a robot and its component elements and payload, in various embodiments techniques disclosed herein may be used to specify, follow, and control a trajectory via velocity control or other derivatives of position, such as acceleration, jerk, etc.

In various embodiments, techniques disclosed herein enable the utilization of all robots (or other agents) to be maximized, through a computationally simplified approach, thereby maximizing overall system throughput. Robot idle time is minimized, since robots do not have to remain idle, or be used less than optimally, while another agent has the shared workspace locked.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A robotic system, comprising:
a communication interface; and
a processor coupled to the communication interface and configured to:
receive via the communication interface, from a first agent included in a plurality of robotically controlled agents associated with a shared workspace, a request to be provided a motion plan to perform a first pick and place task assigned to the first agent; and
determine a first motion plan for the first agent to perform the first pick and place task assigned to the first agent, including by taking into consideration a second motion plan associated with a second agent included in the plurality of robotically controlled agents to perform a second pick and place task assigned to the second agent;
wherein the first motion plan involves the first agent performing the first pick and place task at least in part while the second agent is performing the second pick and place task, and the second motion plan associated with the second agent is taken into consideration at least in part by considering a swept volume associated with at least a remaining uncompleted portion of the second motion plan as an obstacle with which the first agent will not collide while implementing the first motion plan.

2. The system of claim 1, wherein the first agent comprises a robotic arm.

3. The system of claim 1, wherein the first agent comprises a mobile robot.

4. The system of claim 1, wherein the swept volume is computed at least in part by representing one or both of the elements comprising the second agent and the payload being picked and placed by the second agent as a simple convex shape.

5. The system of claim 4, wherein the second motion plan comprises a set of end effector positions and orientations and associated joint configurations at each of a plurality of state points comprising the second motion plan.

6. The system of claim 5, wherein the swept volume represents the space that would be occupied by any part of the second agent or the payload as the second agent moves the payload through the workspace according to the second motion plan.

7. The system of claim 1, wherein the processor is further configured to instruct the first agent to begin implementing the first motion plan at a time associated with completion by the second agent of at least a first portion of the second motion plan.

8. The system of claim 2, wherein the processor is configured to receive via the communication interface, from the second agent, a progress report indicating the progress the second agent has made in implementing the second motion plan.

9. The system of claim 1, wherein the first motion plan and the second motion plan are determined concurrently, prior to the first motion plan being assigned to the first agent or the second motion plan being assigned to the second agent.

10. The system of claim 9, wherein the processor is further configured to select the second agent to begin implementation of the second motion plan prior to the first agent beginning implementation of the first motion plan.

11. The system of claim 1, wherein the processor is further configured to determine an ordered list of items to be picked and placed in the workspace.

12. The system of claim 11, wherein the processor is further configured to determine based at least in part on the ordered list a placement order in which items will be picked and placed.

13. The system of claim 12, wherein the placement order is determined at least in part by considering a plurality of n-tuples of items, n corresponding to a number of agents included in the plurality of robotically controlled agents that are capable of picking and placing items in the workspace and selecting an n-tuple of items to be picked and placed first or next.

14. The system of claim 13, wherein the processor is further configured to determine whether the items comprising the selected n-tuple are candidates to be picked and placed synchronously.

15. The system of claim 14, wherein the processor is configured to determine the items comprising the selected n-tuple are not candidates to be picked and placed synchronously based at least in part on a determination that the respective pick locations and/or placement locations of any two or more items comprising the n-tuple overlap.

16. The system of claim 1, wherein the first motion plan is determined based at least in part on state information received from a computer vision or other perception system.

17. The system of claim 1, wherein the request is received from a first robot controller associated with the first agent.

18. The system of claim 17, wherein the first robot controller operates a control loop at a rate of approximately 1000 Hz and the processor is configured to monitor and control synchronized execution of the first motion plan and the second motion plan at a rate of approximately 500 Hz.

19. A method, comprising:
receiving via a communication interface, from a first agent included in a plurality of robotically controlled agents associated with a shared workspace, a request to be provided a motion plan to perform a first pick and place task assigned to the first agent; and
using a processor to determine a first motion plan for the first agent to perform the first pick and place task assigned to the first agent, including by taking into consideration a second motion plan associated with a second agent included in the plurality of robotically controlled agents to perform a second pick and place task assigned to the second agent;
wherein the first motion plan involves the first agent performing the first pick and place task at least in part while the second agent is performing the second pick and place task, and the second motion plan associated with the second agent is taken into consideration at least in part by considering a swept volume associated with at least a remaining uncompleted portion of the second motion plan as an obstacle with which the first agent will not collide while implementing the first motion plan.

20. A computer program product embodied in a non-transitory computer readable medium, comprising computer instructions for:
receiving via a communication interface, from a first agent included in a plurality of robotically controlled agents associated with a shared workspace, a request to be provided a motion plan to perform a first pick and place task assigned to the first agent; and
determining a first motion plan for the first agent to perform the first pick and place task assigned to the first agent, including by taking into consideration a second motion plan associated with a second agent included in the plurality of robotically controlled agents to perform a second pick and place task assigned to the second agent;
wherein the first motion plan involves the first agent performing the first pick and place task at least in part while the second agent is performing the second pick and place task, and the second motion plan associated with the second agent is taken into consideration at least in part by considering a swept volume associated with at least a remaining uncompleted portion of the second motion plan as an obstacle with which the first agent will not collide while implementing the first motion plan.
